(19) United States
(12) Patent Application Publication
(10) Pub. No.: US 2020/0236857 A1
(43) Pub. Date: Jul. 30, 2020

(54) ROLLER SHELL FOR A CONDITIONING ROLLER

(71) Applicant: DEERE & COMPANY, Moline, IL (US)

(72) Inventors: STEFAN GROSS, RIEGELSBERG (DE); MAXIMILIAN FRENZEL, MUENCHWEILER AN DER RODALB (DE); MANFRED ENGEL, GROSSSTEINHAUSEN (DE); PATRICK JAY McLAWHORN, ZWEIBRUECKEN (DE)

(21) Appl. No.: 16/737,357

(22) Filed: Jan. 8, 2020

(30) Foreign Application Priority Data
Jan. 29, 2019 (DE) 102019201116.0

(51) Int. Cl. A01D 82/02; A01D 43/10

(52) U.S. Cl. CPC A01D 82/02; A01D 43/10

(57) ABSTRACT

A roller shell for a conditioning roller includes a number of teeth which are distributed over the periphery thereof and which extend in an axial direction. Each of the teeth includes a leading flank, a trailing flank and a radial outer surface region having an angulation defined therein. The angulation may include a recess or a step in the outer surface region.

### CROSS-REFERENCE TO RELATED APPLICATIONS

This application claims the benefit of German Patent Application No. 102019201116.0, filed on Jan. 29, 2019, the disclosure of which is hereby incorporated by reference.

### TECHNICAL FIELD

The disclosure generally relates to a roller shell for a crop conditioning roller of a crop harvesting implement.

### BACKGROUND

Field choppers, sometimes referred to as forage harvesters, are used to harvest complete plants or portions thereof which are received during operation by means of a harvest header from a field, are compressed by means of pre-pressing rollers and supplied to a chopping drum whose chopping blades cut the plants together with a counter-blade. Subsequently, the cut plants or plant portions are optionally supplied to a conditioning device and conveyed by means of a subsequent acceleration device into a discharge spout which loads it onto a transport vehicle. The harvested plants are generally used as animal feed or for biogas production. The conditioning device generally comprises two or more rollers which are driven in opposite directions and which are pretensioned against each other by means of a resilient force and between which the chopped material is guided. It is used during the maize harvest in order to strike the grains contained in the chopped material and to improve the digestibility of the feed.

A conventional embodiment of a conditioning device appears in EP 2 098 110 A2 which sets out two cooperating conditioning rollers with teeth which are distributed over the periphery thereof, and which extend in an axial direction over the width of the conditioning rollers. In the prior art, such teeth are saw-tooth-like or constructed as a symmetrical triangle (Catalogue “Krone Big X 750 C Precision-chop forage harvester”, edition 06.14). According to WO 2015/075157 A1, the teeth may comprise flat outer portions which extend in a peripheral direction and which have a predetermined width. The service-life of the teeth is thereby intended to be extended since, even after a specific operating time and the resulting wear of the teeth, portions of the teeth still remain and extend outwardly sufficiently far away from the shell of the conditioning roller to process the harvested material.

With the toothed conditioning rollers described above, there is provided in a peripheral direction of rotation only a single tip per tooth, which cooperates with the harvested material and in particular the grains contained therein. The action of the teeth on the harvested material is consequently limited to a single cutting action per tooth. It would be desirable to improve the action of the conditioning roller.

### SUMMARY

A crop conditioning roller for a harvesting implement is provided. The crop conditioning roller includes a shell extending along a central longitudinal axis. The shell has a body portion and a plurality of teeth. Each of the plurality of teeth extend radially outward from the body portion relative to the central longitudinal axis and extend longitudinally along the central longitudinal axis. The shell is configured for rotation about the central longitudinal axis in a first rotational direction. Each respective one of the plurality of teeth includes a leading flank that leads the respective tooth in the first rotational direction, a trailing flank that trails the respective tooth in the first rotational direction, and a radially outer surface region that is disposed between the leading flank and the trailing flank. The radially outer surface region includes at least one angulation that is disposed between the leading flank and the trailing flank. The angulation extends along the central longitudinal axis.

In one aspect of the disclosure, the at least one angulation of each respective tooth defines a non-linear profile generally perpendicular to a length of the respective tooth along the central longitudinal axis. The at least one angulation of each respective tooth may include, but is not limited to, one of a recess or a step in the radially outer surface region of the respective tooth. In one embodiment, the non-linear profile includes a recess defining one of a rectangular cross sectional shape, a trapezoidal cross sectional shape, a concave cross sectional shape, a triangular cross sectional shape, or a saw tooth cross sectional shape.

In one aspect of the disclosure, the leading flank of each respective tooth extends from the body portion radially outward to a respective leading cusp. The trailing flank of each respective tooth extends from the body portion radially outward to a respective trailing cusp. The radially outer surface region of the respective tooth is disposed between the leading cusp and the trailing cusp.

In one aspect of the disclosure, the radially outer surface region of each respective tooth may include a leading portion having a substantially planar surface that is disposed between the respective leading cusp and the respective angulation of the respective tooth. Additionally, the radially outer surface region of each respective tooth may include a trailing portion having a substantially planar surface that is disposed between the respective angulation and the respective trailing cusp of the respective tooth.

In one embodiment of the disclosure, the leading portion and the trailing portion are disposed at different radially distances from the central longitudinal axis. In another embodiment of the disclosure, the leading portion and the trailing portion are disposed at identical radial distances from the central longitudinal axis.

In one aspect of the disclosure, at least one of the plurality of teeth includes a wear indicator. The wear indicator may include, but is not limited to, a notch extending into the respective tooth.

In one aspect of the disclosure, the roller shell has a number of teeth which are distributed over the periphery thereof and which extend in an axial direction or in a helical manner and which each comprise a flank which leads in a peripheral direction and which rises outwards in a radial direction, a flank which trails in a peripheral direction and which falls inwards in a radial direction and therebetween an outer region which extends in a peripheral direction and which contains at least one (concave) recess and/or at least one step.

It is accordingly proposed to provide the radially outer region of the teeth, which is located in a peripheral direction between the two flanks and which in a radial direction is spaced furthest from the actual roller shell, during the production of the roller shell with an individual tooth arrangement which can be constructed as (one or more) step(s) and/or concave recess(es). In this manner, a type of dual cutting edge or dual blade is obtained (in the form of the two cusps which remain at the end of the recess) or additional edge (in the form of the step) which cooperates once more in a crushing and/or cutting manner with the harvested material and which in particular strikes or crushes the grains contained therein to a greater extent than previous tooth forms. The service-life is extended by the outer region with respect to previous tooth shapes with a triangular or saw-tooth-like cross-section and a permanently continuous gap dimension between adjacent conditioning rollers is obtained. In addition, as a result of the outer region, an increased engagement length, over which the teeth cooperate with the harvested material and greater friction effects are obtained. Finally, as a result of the cooperating roller material, re-sharpening effects of the teeth can be obtained.

The recess may have a rectangular or trapezoidal or curved or triangular or saw-tooth-like cross-section or any combination of these cross-sections.

The outer region may comprise two outer cusps when viewed in a peripheral direction, between which the recess is arranged and the outer faces of the outer cusps may be flat or acute per se in a peripheral direction.

The cusps may be symmetrical or asymmetrical relative to each other. In particular, the leading cusp may be higher or lower and/or wider or narrower and/or more acute or obtuse than the trailing cusp.

The leading and trailing flank may form a frustum of a triangle or a saw tooth or rectangle.

At least one of the teeth of the roller shell may be provided with a wear marking which may in particular be constructed as a notch.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a crop harvesting implement.

FIG. 2 is a schematic perspective view of two conditioning rollers of the crop harvesting implement.

FIGS. 3 to 9 are schematic cross-section views through different embodiments of a section of teeth of the conditioning rollers.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “substantially” or “approximately” are understood by those of ordinary skill to refer to reasonable ranges outside of the given value, for example, general tolerances associated with manufacturing, assembly, and use of the described embodiments.

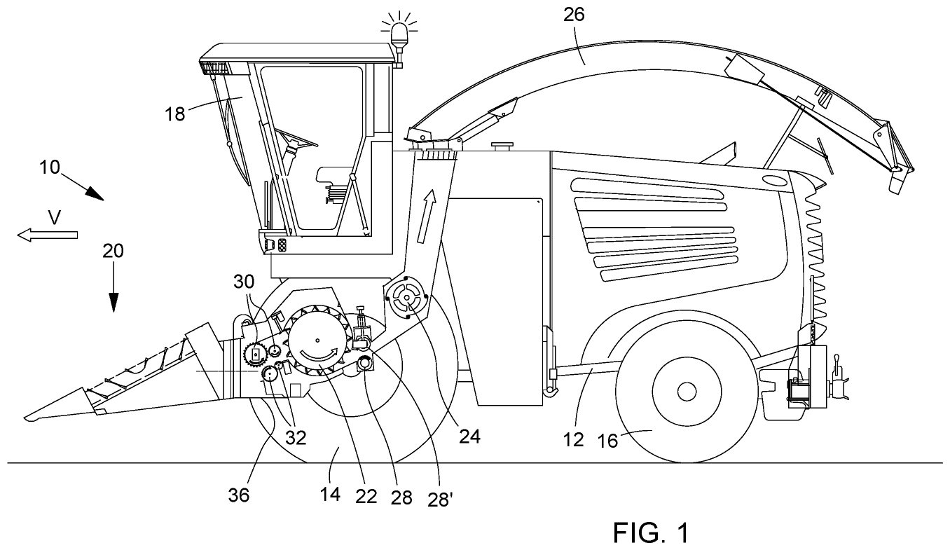

Referring to the Figures, wherein like numerals indicate like parts throughout the several views, crop harvesting implement is generally show at 10. The crop harvesting implement 10 may be referred to hereinafter as self-driving field chopper 10. Referring to FIG. 1, the self-driving field chopper 10 is constructed on a frame 12 which is carried by driven front wheels 14 and steerable rear wheels 16. The operation of the field chopper 10 is carried out from a driver's cab 18 from which a harvest head 20 which is suitable for harvesting stemmed crops can be seen. Using the harvest head 20 which in the embodiment illustrated is a corn header which operates in a row-independent manner, material taken from the ground, for example, corn, cereal or the like, is supplied through upper pre-pressing rollers 30 and lower pre-pressing rollers 32 to a chopper drum 22 which chops it into small pieces and supplies it to a conveyor device 24. The material leaves the field chopper 10 to a trailer being driven alongside via a discharge device 26 which can be adjusted in terms of its position. Between the chopper drum 22 and the conveyor device 24 a conditioning device extends with two conditioning rollers 28, 28′ through which the material which is intended to be conveyed is supplied tangentially to the conveyor device 24. The directional indications—unless otherwise stated—such as front, rear, left and right relate to the forward direction V of the field chopper 10, which extends in FIG. 1 from right to left.

Between the harvested material receiving device 20 and the chopper drum 22, the material is transported through a collection conveyor with lower conveyor rollers 32 and upper conveyor rollers 30, which are fitted inside a collection housing 36. The conveyor rollers 30, 32 are also referred to as pre-pressing rollers since the upper conveyor rollers 30 are pretensioned by means of resilient force against the lower conveyor rollers 32 so that the harvested material is pre-compressed between the conveyor rollers 30, 32 and can be better cut. The chopping blades which are distributed around the periphery of the chopper drum 22 cooperate with a counter-blade in order to chop the material.

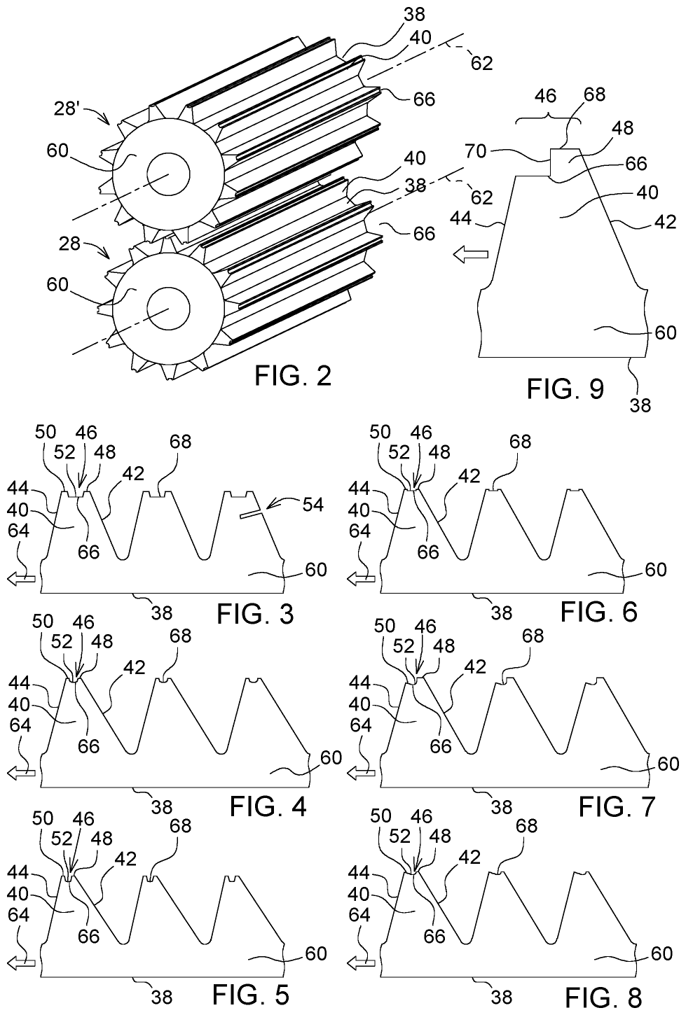

FIG. 2 is a perspective view of the conditioning rollers 28, 28′. Each of the conditioning rollers 28, 28′ include a roller shell 38. The shell 38 includes a body portion 60 which is rotatably supported on the frame 12 by means of support plates, axle stubs and bearings which are known per se and which during harvesting operation can be caused to rotate by means of a suitable drive (not shown) about a central longitudinal axis 62 thereof in a first rotational direction 64. The two conditioning rollers 28, 28′ can be driven at mutually different peripheral speeds relative to each other and are pretensioned with respect to each other by means of resilient force (and/or hydraulic cylinders).

Each roller shell 38 includes a number of identical teeth 40. Each of the teeth 40 extend radially outward from the body portion 60 relative to the central longitudinal axis 62 and extend longitudinally along the central longitudinal axis 62. The teeth 40 are distributed over the periphery of the shell 38 and are shown in different embodiments throughout FIGS. 2 to 9. The teeth 40 extend in the embodiments illustrated in each case over the entire axial length of the roller shell 38 in an axial direction along the central longitudinal axis 62, although it would also be conceivable to allow them to extend only over a portion of the axial length of the roller shell 38, that is to say, to provide perpendicular or inclined grooves between teeth which are adjacent in an axial direction, as set out in DE 10 2011 084 443 B3. The teeth 40 of cooperating rollers 28, 28′ may be offset in an axial direction so that the teeth of one of the rollers penetrate into the grooves of the other roller. In contrast to what is shown in FIG. 2, the teeth 40, instead of extending axially in a precise manner, may be placed in a screw-like or helical manner around the roller shell 38 (see EP 3 417 693 A1).

The spacing of sequential teeth 40 in a peripheral direction, i.e., around a periphery of each respective shell 38, corresponds in terms of order of magnitude to the diameter of the grains which are intended to be struck.

Each of the teeth 40 include, as shown in FIGS. 3 to 9, a leading flank 44, a trailing flank 42, and a radially outer surface region 46 which is disposed between the leading flank 44 and the trailing flank 42. The leading flank 44 leads the respective tooth 40 in the first rotational direction 64. The leading flank 44 of each respective tooth 40 extends from the body portion 60 radially outward to a respective leading cusp 50. The trailing flank 42 trails the respective tooth 40 in the first rotational direction 64. The trailing flank 42 of each respective tooth 40 extends from the body portion 60 radially outward to a respective trailing cusp 48. The radially outer surface region 46 of each respective tooth 40 may include the leading cusp 50 and the trailing cusp 48.

In FIGS. 3 to 8, the trailing flanks 42 are less steep than the leading flanks 44, that is to say, the flanks 42, 44 form a frustum of a saw tooth, which as a result of the outer region 46 which extends substantially in a peripheral direction is missing the tip. In place of the saw tooth frustum form shown, the flanks 42, 44 may also form a frustum of an equilateral triangle or a rectangle or extend precisely in a radial manner. The first rotational direction 64 of the roller shells 38 of FIGS. 3 to 9 is directed to the left, although it could also be directed towards the right, that is to say, the leading and trailing flanks 44, 42 could be transposed.

The radially outer surface region 46 includes at least one angulation 66 disposed between the leading flank 44 and the trailing flank 42. The angulation 66 extends along the central longitudinal axis 62. The angulation 66 of each respective tooth 40 defines a non-linear profile 68 that is generally perpendicular to a length of the respective tooth 40 along the central longitudinal axis 62. The angulation 66 of each respective tooth 40 may include, but is not limited to, one of a recess 52 or a step 70 in the radially outer surface region 46 of the respective tooth 40.

The radially outer surface region 46 of each respective tooth 40 may include the leading cusp 50, which includes a substantially planar surface that is disposed between the respective leading flank 44 and the respective angulation 66 of the respective tooth 40. Similarly, the radially outer surface region 46 of each respective tooth 40 may include the trailing cusp 48, which includes a substantially planar surface that is disposed between the respective angulation 66 and the respective trailing flank 42 of the respective tooth 40.

The outer region 46 in the embodiment according to FIG. 3 is not flat per se, but instead includes a recess 52 which is arranged between the two cusps 48, 50. The recess 52 has a trapezoidal (bathtub-like) cross-section, that is to say, the dimension of the recess 52 measured in the peripheral direction is smaller at the base thereof than at the radially outer end thereof. The cross-section of the recess 52 could, however, also be rectangular. The cusps 48, 50 also have a trapezoidal cross-section, wherein the dimension of the cusps measured in the peripheral direction at the radially outer end thereof is smaller than at the radially inner end thereof (at which the full tooth 40 begins). The outer flanks of the cusps 48, 52 which extend in a peripheral direction are substantially flat, i.e., per se flat, but may be slightly circular in accordance with the radius of the envelope circle of the teeth 40.

The cusps 48, 50 and the recess 52 accordingly form (in addition to a first edge formed on the leading flank 44 of the tooth 40 and the leading cusp 50) on the leading flank of the trailing cusp 48 a second edge which contributes to striking the grains in the harvested material processed by the conditioning roller 28, 28′.

The embodiment of FIG. 4 substantially corresponds to that of FIG. 3, but the recesses 52 are U-shaped or curved in cross-section. In addition, they are shorter in a peripheral direction than the recesses 52 of the embodiment according to FIG. 3.

The embodiment of FIG. 5 corresponds substantially to that according to FIG. 4, but the recesses 52 are deeper than the recesses 52 of the embodiment according to FIG. 4.

The embodiment of FIG. 6 substantially corresponds to that of FIG. 4, but the recesses 52 are deeper than the recesses 52 of the embodiment according to FIG. 4.

The embodiment of FIG. 7 substantially corresponds to that according to FIG. 3, but the leading portion 72 of the leading cusp 50 is smaller than the trailing portion 74 of the trailing cusp 48, and the recess 52 has a leading flank which extends inwards in a relatively flat manner from the leading cusp 50 and a trailing flank which rises in a relatively steep manner outwards to the trailing cusp 48 to form a step 70.

The embodiment of FIG. 8 substantially corresponds to that according to FIG. 7, but the trailing cusp 48 is lower and narrower.

In the embodiment according to FIG. 9, the recess 52 has been omitted. The leading portion 72 forms with the trailing portion 74 thereof a step 70 which also serves to strike the grains.

The leading portion 72 of the leading cusp 50 and the trailing portion 74 of the trailing cusp 48, may be disposed at different radially distances from the central longitudinal axis 62. Alternatively, the leading portion 72 of the leading cusp 50 and the trailing portion 74 of the trailing cusp 48 may be disposed at an identical radial distance from the central longitudinal axis 62.

One or more of the teeth 40 of the roller shell 38 may, as shown by way of example in FIG. 3, be provided with a wear marking or indicator 54 which extends axially over a portion or the entire length of the tooth 40 and which is in the form of a notch or a groove. The user can identify with reference to a missing wear marking that a potentially worn roller shell 38 or the entire conditioning roller 28, 28′ has to be replaced. The wear indicator 54 may also be used independently of the tooth shape, that is to say, also with teeth 40 of any cross-section, for example, triangular or saw-tooth-like or trapezoidal.

In order to reduce the wear of the teeth 40, the regions which are generally or particularly subjected to wear (for example, the flanks 42, 44, cusps 48, 50 (or the outer upper sides or tips thereof), radii, shoulders, recesses 52) may be provided in each case completely or partially with a wear protection coating. The teeth 40 or the regions mentioned may also alternately be provided with the wear protection coating, that is to say, some teeth 40 may remain uncoated. The recesses 52 may, as shown in the Figures, be constructed as a (chamfered) groove, or they are constructed as cylindrical or conical bores or milled grooves, that is to say, between the recesses 52 the original material of the teeth 40 remains in an axial direction.

Any mixed shapes are also possible, in which on a single roller shell 38 in an axial direction and/or peripheral direction differently shaped teeth 40 follow each other. Teeth 40 of one of the FIGS. 3 to 9 could thus alternate with teeth 40, for example, of another of the FIGS. 3 to 9 or with a conventional tooth form without a step and recess in the peripheral direction, or even three or more tooth forms may alternate. It is also conceivable for the tooth form to vary in the manner described in an axial direction, that is to say, to provide a portion of the length of the teeth 40 with a shape according to one of the FIGS. 3 to 9 and to provide it over another portion with a different shape (for example, one of the FIGS. 3 to 9 or with a conventional tooth shape without a step and recess).

Finally, it would be conceivable to construct the first conditioning roller 28 in accordance with one of the Figures discussed above and to provide the second conditioning roller 28′ with a conventional tooth arrangement which extends axially or in a helical manner, or to provide the second conditioning roller 28′ with a tooth arrangement according to another of the Figures discussed above.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A crop conditioning roller for a harvesting implement, the crop conditioning roller comprising:
a shell extending along a central longitudinal axis and having a body portion and a plurality of teeth, with each of the plurality of teeth extending radially outward from the body portion relative to the central longitudinal axis and extending longitudinally along the central longitudinal axis;
wherein the shell is configured for rotation about the central longitudinal axis in a first rotational direction;
wherein each respective one of the plurality of teeth includes a leading flank that leads the respective tooth in the first rotational direction, a trailing flank that trails the respective tooth in the first rotational direction, and a radially outer surface region disposed between the leading flank and the trailing flank; and
wherein the radially outer surface region includes at least one angulation disposed between the leading flank and the trailing flank and extending along the central longitudinal axis.

2. The crop conditioning roller set forth in claim 1, wherein the at least one angulation of each respective tooth defines a non-linear profile generally perpendicular to a length of the respective tooth along the central longitudinal axis.

3. The crop conditioning roller set forth in claim 2, wherein the at least one angulation of each respective tooth includes one of a recess or a step in the radially outer surface region of the respective tooth.

4. The crop conditioning roller set forth in claim 2, wherein the non-linear profile includes a recess defining one of a rectangular cross sectional shape, a trapezoidal cross sectional shape, a concave cross sectional shape, a triangular cross sectional shape, or a saw tooth cross sectional shape.

5. The crop conditioning roller set forth in claim 1, wherein the leading flank of each respective tooth extends from the body portion radially outward to a respective leading cusp, and the trailing flank of each respective tooth extends from the body portion radially outward to a respective trailing cusp, with the radially outer surface region of the respective tooth disposed between the leading cusp and the trailing cusp.

6. The crop conditioning roller set forth in claim 5, wherein the leading cusp has a substantially planar surface that is disposed between the respective leading flank and the respective angulation of the respective tooth.

7. The crop conditioning roller set forth in claim 6, wherein the trailing cusp has a substantially planar surface that is disposed between the respective angulation and the respective trailing flank of the respective tooth.

8. The crop conditioning roller set forth in claim 7, wherein the leading cusp and the trailing cusp are disposed at different radially distances from the central longitudinal axis.

9. The crop conditioning roller set forth in claim 7, wherein the leading cusp and the trailing cusp are disposed at an identical radial distance from the central longitudinal axis.

10. The crop conditioning roller set forth in claim 1, wherein at least one of the plurality of teeth includes a wear indicator.

11. A crop conditioning roller for a harvesting implement, the crop conditioning roller comprising:
a shell extending along a central longitudinal axis and having a body portion and a plurality of teeth, with each of the plurality of teeth extending longitudinally along the central longitudinal axis;
wherein the shell is configured for rotation about the central longitudinal axis in a first rotational direction;
wherein each respective one of the plurality of teeth includes a leading flank that leads the respective tooth in the first rotational direction and extends radially outward from the body portion relative to the central longitudinal axis to a leading cusp;
wherein each respective one of the plurality of teeth includes a trailing flank that trails the respective tooth in the first rotational direction and extends radially outward from the body portion relative to the central longitudinal axis to a trailing cusp;
wherein each respective one of the plurality of teeth includes a radially outer surface region disposed between the leading flank and the trailing flank;
wherein the radially outer surface region of each respective tooth includes the leading cusp having a substantial planar shape and disposed adjacent the respective leading flank;
wherein the radially outer surface region of each respective tooth includes the trailing cusp having a substantial planar shape and disposed adjacent the respective trailing flank; and
wherein the radially outer surface region of each respective tooth includes at least one angulation disposed between the leading cusp and the trailing cusp and extending along the central longitudinal axis.

12. The crop conditioning roller set forth in claim 11, wherein the at least one angulation of each respective tooth defines a non-linear profile generally perpendicular to a length of the respective tooth along the central longitudinal axis.

13. The crop conditioning roller set forth in claim 11, wherein the at least one angulation of each respective tooth includes one of a recess or a step in the radially outer surface region of the respective tooth.

14. The crop conditioning roller set forth in claim 12, wherein the non-linear profile includes a recess defining one of a rectangular cross sectional shape, a trapezoidal cross sectional shape, a concave cross sectional shape, a triangular cross sectional shape, or a saw tooth cross sectional shape.

15. The crop conditioning roller set forth in claim 11, wherein the leading cusp and the trailing cusp are disposed at different radially distances from the central longitudinal axis.

16. The crop conditioning roller set forth in claim 11, wherein the leading cusp and the trailing cusp are disposed at identical radial distances from the central longitudinal axis.
